(19) United States
(12) Patent Application Publication
(10) Pub. No.: US 2025/0363675 A1
(43) Pub. Date: Nov. 27, 2025

(54) DECODING METHOD AND DECODING DEVICE

(71) Applicant: Panasonic Intellectual Property Corporation of America, Torrance, CA (US)

(72) Inventors: Atsushi ITO, Osaka (JP); Toshiyasu SUGIO, Osaka (JP); Noritaka IGUCHI, Osaka (JP); Takahiro NISHI, Nara (JP)

(21) Appl. No.: 19/292,288

(22) Filed: Aug. 6, 2025

Related U.S. Application Data
(63) Continuation of application No. PCT/JP2024/004761, filed on Feb. 13, 2024.
(60) Provisional application No. 63/447,443, filed on Feb. 22, 2023.
(60) Provisional application No. 63/542,159, filed on Oct. 3, 2023.

(51) Int. Cl. G06T 9/40

(52) U.S. Cl. CPC G06T 9/40

(57) ABSTRACT

A decoding method that is a decoding method for decoding three-dimensional points includes: determining whether to locate the three-dimensional points on a TriSoup triangle, based on a first position of a first centroid vertex in a first node that is a unit for storing the three-dimensional points included in an octree structure; and locating or not locating the three-dimensional points on the TriSoup triangle, based on a result of the determining. The first centroid vertex and the TriSoup triangle are used in a TriSoup scheme.

### CROSS REFERENCE TO RELATED APPLICATIONS

This is a continuation application of PCT International Application No. PCT/JP2024/004761 filed on Feb. 13, 2024, designating the United States of America, which is based on and claims priority of U.S. Provisional Patent Application No. 63/447,443 filed on Feb. 22, 2023 and U.S. Provisional Patent Application No. 63/542,159 filed on Oct. 3, 2023. The entire disclosures of the above-identified applications, including the specifications, drawings and claims are incorporated herein by reference in their entirety.

### FIELD

The present disclosure relates to a decoding method, an encoding method, a decoding device, and an encoding device.

### BACKGROUND

Devices or services utilizing three-dimensional data are expected to find their widespread use in a wide range of fields, such as computer vision that enables autonomous operations of cars or robots, map information, monitoring, infrastructure inspection, and video distribution. Three-dimensional data is obtained through various means including a distance sensor such as a rangefinder, as well as a stereo camera and a combination of a plurality of monocular cameras.

Methods of representing three-dimensional data include a method known as a point cloud scheme that represents the shape of a three-dimensional structure by a point cloud in a three-dimensional space. In the point cloud scheme, the positions and colors of a point cloud are stored. While point cloud is expected to be a mainstream method of representing three-dimensional data, a massive amount of data of a point cloud necessitates compression of the amount of three-dimensional data by encoding for accumulation and transmission, as in the case of a two-dimensional moving picture (examples include Moving Picture Experts Group-4 Advanced Video Coding (MPEG-4 AVC) and High Efficiency Video Coding (HEVC) standardized by MPEG).

Meanwhile, point cloud compression is partially supported by, for example, an open-source library (Point Cloud Library) for point cloud-related processing.

Furthermore, a technique for searching for and displaying a facility located in the surroundings of the vehicle by using three-dimensional map data is known (see, for example, Patent Literature (PTL) 1).

### CITATION LIST

### Patent Literature

PTL 1: International Publication WO 2014/020663

### SUMMARY

### Technical Problem

Furthermore, as an encoding scheme, there are cases where an irreversible compression scheme is used. In such a case, the decoded point cloud does not perfectly match the original point cloud. Therefore, there is a demand for improving the reproducibility of a point cloud to be decoded.

The present disclosure has an object to provide a decoding method, an encoding method, a decoding device, or an encoding device capable of improving reproducibility of a point cloud to be decoded.

### Solution to Problem

A decoding method according to one aspect of the present disclosure is a decoding method for decoding three-dimensional points, the decoding method comprising: determining whether to locate the three-dimensional points on a TriSoup triangle, based on a first position of a first centroid vertex in a first node that is a unit for storing the three-dimensional points included in an octree structure; and locating or not locating the three-dimensional points on the TriSoup triangle, based on a result of the determining, wherein the first centroid vertex and the TriSoup triangle are used in a TriSoup scheme.

### Advantageous Effects

The present disclosure can provide a decoding method, an encoding method, a decoding device, or an encoding device capable of improving reproducibility of a point cloud to be decoded.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example of an original point cloud according to Embodiment 1.

FIG. 2 is a diagram illustrating an example of a trimmed octree according to Embodiment 1.

FIG. 3 is a diagram illustrating an example in which a leaf-node according to Embodiment 1 is two-dimensionally displayed.

FIG. 4 is a diagram for describing a method for generating a centroid vertex according to Embodiment 1.

FIG. 5 is a diagram for describing the method for generating a centroid vertex according to Embodiment 1.

FIG. 6 is a diagram illustrating an example of vertex information according to Embodiment 1

FIG. 7 is a diagram illustrating an example of a TriSoup surface according to Embodiment 1.

FIG. 8 is a diagram for describing point cloud reconstruction processing according to Embodiment 1.

FIG. 9 is a diagram illustrating an example of a point cloud according to Embodiment 1.

FIG. 10 is a diagram illustrating an example of centroid vertex generation according to Embodiment 1.

FIG. 11 is a diagram illustrating an example of triangle (TriSoup surface) generation according to Embodiment 1.

FIG. 12 is a diagram illustrating an example of face vertex generation according to Embodiment 1.

FIG. 13 is a diagram illustrating an example of generation of edge vertices and centroid vertices according to Embodiment 1.

FIG. 14 is a diagram for describing an adjusting method of edge vertices according to Embodiment 1.

FIG. 15 is a diagram for describing another adjusting method of edge vertices according to Embodiment 1.

FIG. 16 is a diagram illustrating an example of a plurality of vertices according to Embodiment 1.

FIG. 17 is a diagram illustrating an example of vertices generated in four nodes according to Embodiment 1.

FIG. 18 is a diagram illustrating an example of vertices generated in four nodes according to Embodiment 1.

FIG. 19 is a diagram illustrating an example of vertices generated in four nodes according to Embodiment 1.

FIG. 20 is a diagram illustrating a dependency relationship of information in reconstruction of vertex coordinates according to Embodiment 1.

FIG. 21 is a diagram illustrating an example of vertices generated in four nodes according to Embodiment 1.

FIG. 22 is a flowchart of decoding processing according to Embodiment 1.

FIG. 23 is a flowchart of generation processing of a plurality of triangles according to Embodiment 1.

FIG. 24 is a diagram illustrating an example of vertices of neighboring nodes according to Embodiment 2.

FIG. 25 is a diagram illustrating an example of vertices of neighboring nodes according to Embodiment 2.

FIG. 26 is a flowchart of generation processing of a plurality of triangles according to Embodiment 2.

FIG. 27 is a flowchart of decoding processing according to an embodiment.

FIG. 28 is a block diagram of a decoding device according to an embodiment.

FIG. 29 is a block diagram of an encoding device according to an embodiment.

### DESCRIPTION OF EMBODIMENTS

A decoding method according to one aspect of the present disclosure is a decoding method for decoding three-dimensional points, and includes: determining whether to locate the three-dimensional points on a TriSoup triangle, based on a first position of a first centroid vertex in a first node that is a unit for storing the three-dimensional points included in an octree structure; and locating or not locating the three-dimensional points on the TriSoup triangle, based on a result of the determining. The first centroid vertex and the TriSoup triangle are used in a TriSoup scheme.

Accordingly, the decoding method can appropriately generate the TriSoup triangle according to the result of the determining, and can improve the reproducibility of a point cloud decoded.

For example, in the determining, whether to locate the three-dimensional points on the TriSoup triangle may be determined based on the first position and a second position of a second vertex, the second vertex being provided on a first surface of the first node except for edges of the first surface, and the second vertex may be a vertex of the TriSoup triangle. Accordingly, the decoding method can improve the accuracy of determination by using the second position of the second vertex, in addition to the first position of the first centroid vertex.

For example, in the determining, whether to locate the three-dimensional points on the TriSoup triangle may be determined based on the first position, the second position, and a third position of a third vertex, the third vertex being provided on a second surface of the first node except for edges of the second surface, the second surface may be orthogonal to the first surface, and the third vertex may be a vertex of the TriSoup triangle. Accordingly, the decoding method can improve the accuracy of determination by using the third position of the third vertex, in addition to the first position of the first centroid vertex and the second position of the second vertex.

For example, in the determining, whether to locate the three-dimensional points on the TriSoup triangle may be determined based on (i) first information that indicates whether the first centroid vertex is connected to a second centroid vertex in a second node adjacent to the first node by the TriSoup triangle and (ii) second information that indicates whether the first centroid vertex is connected to a third centroid vertex in a third node adjacent to the first node by the TriSoup triangle. For example, when the first centroid vertex, the second centroid vertex, and the third centroid vertex are connected by the TriSoup triangle, a reconstructed flat surface that spans the first node, the second node, and the third node is substantially generated. In this case, when the plurality of three-dimensional points are located on the TriSoup triangle, the reconstruction accuracy of a point cloud is increased. Therefore, according to this decoding method, it is possible to realize highly accurate determination with a small amount of processing only by referring to the first information and the second information.

For example, a bitstream may include control information that indicates whether the determining is performed. Accordingly, the decoding method can switch whether or not to perform the determination.

For example, the control information may be provided for each of nodes. Accordingly, the decoding method can switch whether or not to perform the determination for each of nodes.

For example, when it is determined to locate the three-dimensional points on the TriSoup triangle, a bitstream need not include information about positions of edge vertices. Accordingly, the data amount of the bitstream can be reduced.

A decoding method according to one aspect of the present disclosure is a decoding method for decoding three-dimensional points, and includes: decoding edge vertices and a first centroid vertex that are provided in a first node, according to a TriSoup scheme, the first node being a unit for storing the three-dimensional points included in an octree structure; and adjusting at least one of positions of the edge vertices to generate a TriSoup triangle on which the three-dimensional points are to be located.

Accordingly, for example, when a flat surface (TriSoup triangle) cannot be correctly reconstructed from a plurality of vertices in the first node, the decoding method can reconstruct a correct flat surface by adjusting the edge vertex. Thus, the reproducibility of a point cloud to be decoded can be improved.

For example, in the adjusting, the at least one of the positions may be adjusted based on positions of the first centroid vertex, a second vertex, and a third vertex, the TriSoup triangle may be defined by the second vertex and the third vertex, the second vertex may be provided on a first surface of the first node except for edges of the first surface, the third vertex may be provided on a second surface of the first node except for edges of the second surface, and the second surface may be orthogonal to the first surface. Accordingly, the decoding method can adjust the position of at least one edge vertex so that a flat surface can be correctly reconstructed.

For example, an accuracy of the positions of the edge vertices may be lower than an accuracy of a position of the first centroid vertex and an accuracy of adjusted positions of the edge vertices. Accordingly, when a flat surface cannot be correctly reconstructed due to low accuracy of the positions of the edge vertices, the decoding method can correctly reconstruct a flat surface.

A decoding method according to one aspect of the present disclosure is a decoding method for decoding three-dimensional points, and includes: calculating, in a first direction, an average position of four positions of four vertices each of which is included in a different one of four nodes. The four nodes include a common edge that is parallel to the first direction. Each of the four nodes is a unit for storing three-dimensional points included in an octree structure. The decoding method further includes generating an edge vertex on the common edge, at the average position. The edge vertex and each of the four vertices are used in a TriSoup scheme that generates three-dimensional points on a TriSoup triangle.

Accordingly, for example, even when a flat surface (TriSoup triangle) cannot be correctly reconstructed from a plurality of original vertices of the four nodes, the decoding method can reconstruct a correct flat surface by using the generated edge vertex. Thus, the reproducibility of a point cloud to be decoded can be improved.

For example, an original position of the edge vertex may be stored into a bitstream, and in the generating, the original position may be changed to the average position on the common edge. Accordingly, since the edge vertex can be generated in a decoding device, it is unnecessary to generate additional information or the like in an encoding device. Thus, the processing amount in the encoding device can be reduced.

For example, the four vertices may be centroid vertices or face vertices, and each of the face vertices may be provided on a surface of a corresponding one of the four nodes except for edges of the corresponding one of the four nodes. Accordingly, the decoding method can appropriately generate the edge vertex by using the average position of the four vertices.

For example, the four nodes may include: a first node; a second node adjacent to the first node in a second direction orthogonal to the first direction; a third node adjacent to the first node in a third direction orthogonal to each of the first direction and the second direction; and a fourth node adjacent to the second node in the third direction and adjacent to the third node in the second direction.

A decoding device according to one aspect of the present disclosure is a decoding device that decodes three-dimensional points, and includes a processor and a memory. Using the memory, the processor: determines whether to locate the three-dimensional points on a TriSoup triangle, based on a first position of a first centroid vertex in a first node that is a unit for storing the three-dimensional points included in an octree structure; and locates or does not locate the three-dimensional points on the TriSoup triangle, based on a result of the determining. The first centroid vertex and the TriSoup triangle are used in a TriSoup scheme.

A decoding device according to one aspect of the present disclosure is a decoding device that decodes three-dimensional points, and includes a processor and a memory. Using the memory, the processor: decodes edge vertices and a first centroid vertex that are provided in a first node, according to a TriSoup scheme, the first node being a unit for storing the three-dimensional points included in an octree structure; and adjusts at least one of positions of the edge vertices to generate a TriSoup triangle on which the three-dimensional points are to be located.

A decoding device according to one aspect of the present disclosure is a decoding device that decodes three-dimensional points, and includes a processor and a memory. Using the memory, the processor calculates, in a first direction, an average position of four positions of four vertices each of which is included in a different one of four nodes. The four nodes include a common edge that is parallel to the first direction. Each of the four nodes is a unit for storing three-dimensional points included in an octree structure. The processor further generates an edge vertex on the common edge, at the average position. The edge vertex and each of the four vertices are used in a TriSoup scheme that generates three-dimensional points on a TriSoup triangle.

It is to be noted that these general or specific aspects may be implemented as a system, a method, an integrated circuit, a computer program, or a computer-readable recording medium such as a CD-ROM, or may be implemented as any combination of a system, a method, an integrated circuit, a computer program, and a recording medium.

Hereinafter, embodiments will be specifically described with reference to the drawings. It is to be noted that each of the following embodiments indicate a specific example of the present disclosure. The numerical values, shapes, materials, constituent elements, the arrangement and connection of the constituent elements, steps, the processing order of the steps, etc., indicated in the following embodiments are mere examples, and thus are not intended to limit the present disclosure. Among the constituent elements described in the following embodiments, constituent elements not recited in any one of the independent claims will be described as optional constituent elements.

### Embodiment 1

Hereinafter, an encoding device (three-dimensional data encoding device) and a decoding device (three-dimensional data decoding device) according to the present embodiment will be described. The encoding device encodes three-dimensional data to thereby generate a bitstream. The decoding device decodes the bitstream to thereby generate three-dimensional data.

Three-dimensional data is, for example, three-dimensional point cloud data (also called point cloud data). A point cloud, which is a set of three-dimensional points, represents the three-dimensional shape of an object. The point cloud data includes position information and attribute information on the three-dimensional points. The position information indicates the three-dimensional position of each three-dimensional point. It should be noted that position information may also be called geometry information. For example, the position information is represented using an orthogonal coordinate system or a polar coordinate system.

Attribute information indicates color information, reflectance, infrared information, a normal vector, or time-of-day information, for example. One three-dimensional point may have a single item of attribute information or have a plurality of kinds of attribute information.

It should be noted that although mainly the encoding and decoding of position information will be described below, the encoding device may perform encoding and decoding of attribute information.

### [TriSoup Scheme]

The encoding device according to the present embodiment encodes position information by using a Triangle-Soup (TriSoup) scheme.

The TriSoup scheme is an irreversible compression scheme for encoding position information on point cloud data. In the TriSoup scheme, an original point cloud being processed is replaced by a set of triangles, and the point cloud is approximated on the planes of the triangles. Specifically, the original point cloud is replaced by vertex information on vertexes (hereinafter also referred to as vertices) within each node, and the vertexes are connected with each other to form a group of triangles. Furthermore, the vertex information for generating the triangles is stored in a bitstream, which is sent to the decoding device.

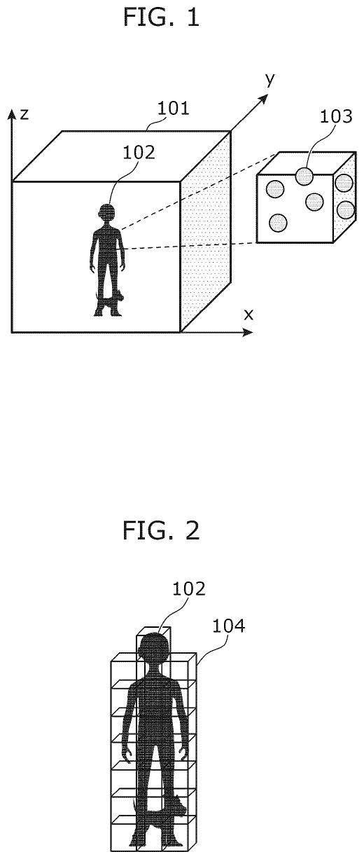

Now, encoding processing using the TriSoup scheme will be described. FIG. 1 is a diagram illustrating an example of an original point cloud. As shown in FIG. 1, point cloud 102 of an object is in target space 101 and includes points 103.

First, the encoding device divides the original point cloud into an octree up to a predetermined depth. In octree division, a target space is divided into eight nodes (subspaces), and 8-bit information (an occupancy code) indicating whether each node includes a point cloud is generated. A node that includes a point cloud is further divided into eight nodes, and 8-bit information indicating whether these eight nodes each include a point cloud is generated. This processing is repeated up to a predetermined layer.

Here, typical octree encoding divides nodes until the number of point clouds in each node reaches, for example, one or a threshold. In contrast, the TriSoup scheme performs octree division up to a layer along the way and not for layers lower than that layer. Such an octree up to a midway layer is called a trimmed octree.

FIG. 2 is a diagram illustrating an example of a trimmed octree. As shown in FIG. 2, point cloud 102 is divided into leaf-nodes 104 (lowest-layer nodes) of a trimmed octree.

The encoding device then performs the following processing for each leaf-node 104 of the trimmed octree. It should be noted that a leaf-node may hereinafter also be simply referred to as a node. The encoding device generates vertexes on edges of the node as representative points of the point cloud near the edges. These vertexes are called edge vertexes. For example, an edge vertex is generated on each of a plurality of edges (for example, four parallel edges).

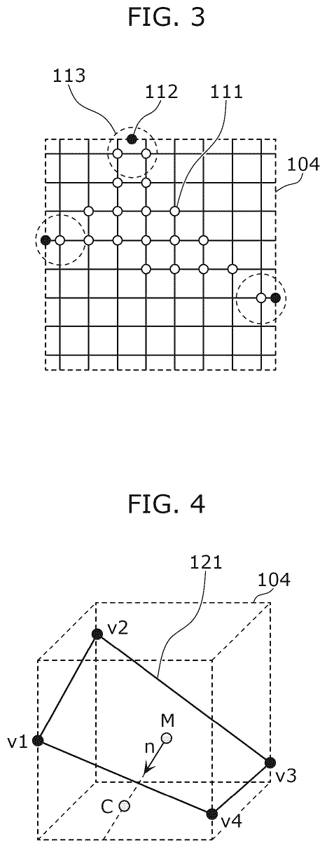

FIG. 3 is a diagram illustrating an example of two-dimensional display of leaf-node 104, for example, the xy-plane viewed along the z-direction shown in FIG. 1. As shown in FIG. 3, edge vertexes 112 are generated on edges based on points near the edges, among points 111 within leaf-node 104.

It should be noted that the dotted lines in FIG. 3 along the perimeter of leaf-node 104 represent the edges. Also in this example, each edge vertex 112 is generated at a weighted average of the positions of points within the distance 1 from the corresponding edge (points within each range 113 in FIG. 3). It should be noted that the unit of distance may be, by way of example and not limitation, the resolution of the point cloud. Although the distance (the threshold) is 1 in this example, the distance may be a value other than 1 or may be variable.

The encoding device then generates a vertex inside the node as well, based on a point cloud located in the direction of the normal to the plane that includes edge vertexes. This vertex is called a centroid vertex.

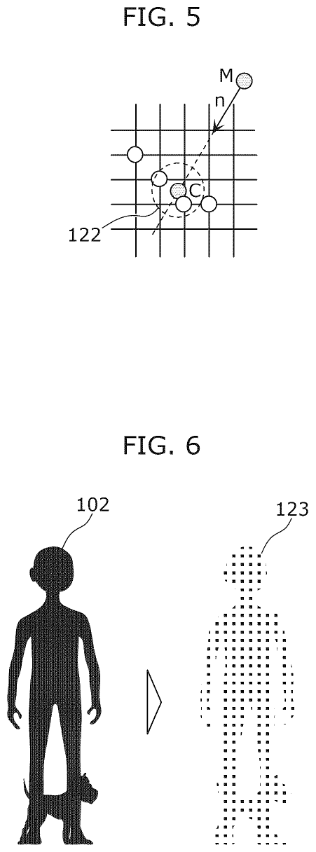

FIGS. 4 and 5 are diagrams for describing a method for generating the centroid vertex. First, the encoding device selects, for example, four points as representative points from a group of edge vertexes. In the example shown in FIG. 4, edge vertexes v1 to v4 are selected. The encoding device then calculates approximate plane 121 passing through the four points. The encoding device then calculates normal n to approximate plane 121 and average coordinates M of the four points. The encoding device then generates centroid vertex C at weighted-average coordinates of one or more points near a half line extending along normal n from average coordinates M (e.g., points within range 122 shown in FIG. 5).

The encoding device then entropy-encodes vertex information, which is information on the edge vertexes and the centroid vertex, and stores the encoded vertex information in a geometry data unit (hereinafter referred to as a GDU) included in the bitstream. It should be noted that, in addition to the vertex information, the GDU includes information indicating the trimmed octree.

FIG. 6 is a diagram illustrating an example of the vertex information. The above processing transforms point cloud 102 into vertex information 123, as shown in FIG. 6.

Now, decoding processing for the bitstream generated as above will be described. First, the decoding device decodes the GDU from the bitstream to obtain the vertex information. The decoding device then connects the vertexes to generate a TriSoup surface, which is a group of triangles.

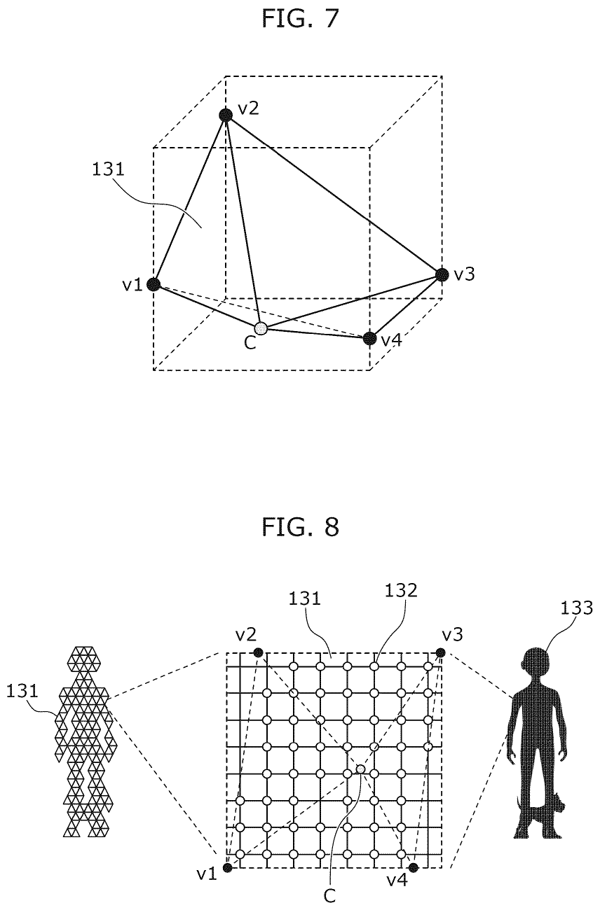

FIG. 7 is a diagram illustrating an example of the TriSoup surface. In the example shown in FIG. 7, four edge vertexes v1 to v4 and centroid vertex C are generated based on the vertex information. Furthermore, triangles 131 (a TriSoup surface) are generated, each having centroid vertex C and two edge vertexes as its vertexes. For example, a pair of two edge vertexes on a pair of two adjacent edges is selected to form triangle 131 having the selected pair of edge vertexes and the centroid vertex as its vertexes.

FIG. 8 is a diagram for describing point cloud reconstruction processing. The above processing is performed for each leaf-node to generate a three-dimensional model that represents the object with triangles 131, as shown in FIG. 8.

The decoding device then generates points 132 at regular intervals on the surface of triangles 131 to reconstruct the position information on point cloud 133.

### [Example of Representation of Ridge Line of Point Cloud Surface]

According to the TriSoup scheme, the shape of the ridge line (ridge) across the adjacent nodes cannot be reconstructed in some cases. In contrast, the encoding device generates the face vertex on the surface in contact with the neighboring node, and reconstructs the point cloud also on the surface of the triangle generated based on the centroid vertex, the face vertices, and the edge vertices.

For example, in a case where a bent portion of the point cloud distribution (point cloud surface) is distributed within the leaf node, the surface model made by connecting the vertices cannot reproduce the shape of the original point cloud in some cases because the corner of the point cloud surface and the edge do not intersect each other and no vertex is formed at the position of the corner.

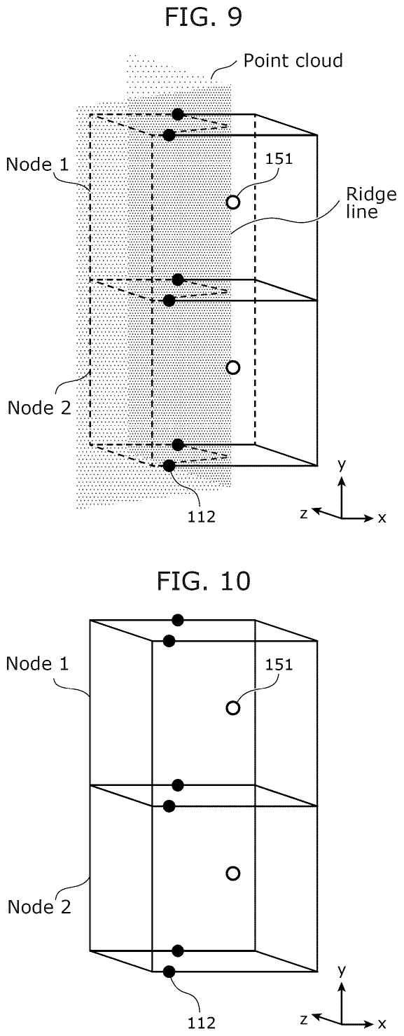

FIG. 9 is a diagram illustrating an example of a point cloud in a case where a point cloud is distributed across node 1 and node 2, and a ridge line is formed. As shown in FIG. 9, based on the point cloud distribution close to edges, edge vertices 112 are generated.

FIG. 10 is a diagram illustrating a centroid vertex generation example in this case. As shown in FIG. 10, each centroid vertex 151 is formed in the normal direction of an approximate plane of the edge vertex group.

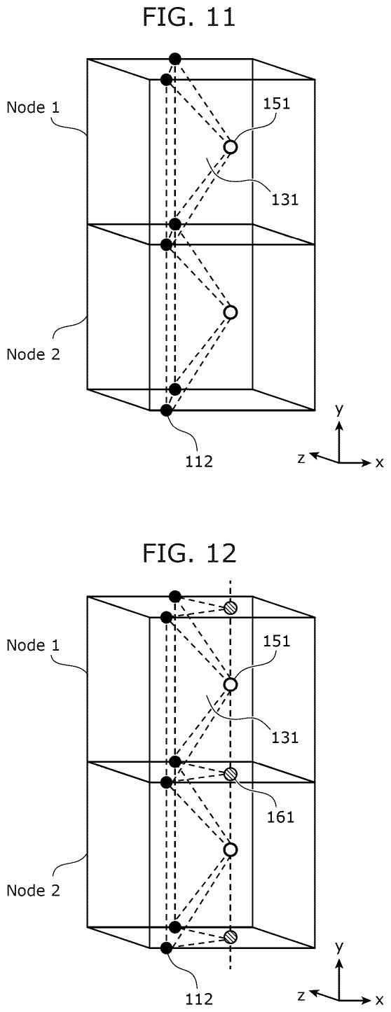

FIG. 11 is a diagram illustrating a generation example of triangles 131 (TriSoup surface) in this case. As shown in FIG. 11, each triangle 131 is generated by connecting a plurality of vertices (plurality of edge vertices and a centroid vertex). In this case, as illustrated in FIG. 11, the point cloud in the vicinity of the node boundary cannot be reproduced.

This is because the centroid vertex successfully samples the original point cloud surface but the current scheme can create no vertex between two centroid vertices of two neighboring nodes. For example, in a case where a ridge line is continuously distributed in the node along the direction of any of x, y, and z axes, no vertex corresponding to the ridge line is formed because the ridge line is not across any edge. Accordingly, this problem occurs.

In the present embodiment, the encoding device predicts the ridge line of the point cloud surface. Upon determination that two neighboring nodes have the same ridge line, this device transfers, to the decoding device, information for connecting two centroid vertices of the two neighboring nodes by a line segment. This information is, for example, 1-bit information assigned to each surface between nodes.

The decoding device connects the centroid vertices using this information, and generates a new vertex (face vertex) at an intersection between the obtained line segment and a shared surface between the nodes. When generating triangle 131, the decoding device can reproduce the ridge line using the new vertex.

Since the coordinate position of the face vertex is not quantized, a problem of positional deviation due to quantization is not present.

FIG. 12 is a diagram illustrating an example of generation of a face vertex. As illustrated in FIG. 12, the decoding device can reproduce a ridge line by generating face vertex 161, and generating triangle 131 by using face vertex 161.

With the above-described technique, since a point-cloud surface in the vicinity a node boundary can be reproduced, a decoded point cloud closer to an original point cloud can be obtained. It should be noted that, in the above-described description, since the point-cloud surface is merely used for describing a problem related to a ridge line, and the ridge line need not be actually obtained.

### [Problem of Flat Surface Reconstruction]

When reconstructing a point cloud including a flat surface by using these various vertices, there is a possibility that the surface of the reconstructed point cloud does not form a flat surface, and unevenness that does not exist in the original point cloud occurs. Probable causes are as follows. It should be noted that this problem occurs irrespective of whether or not a surface that spans a neighboring node is used by using a face vertex. For example, when the accuracy of an edge vertex is lower than the accuracy of a centroid vertex, a difference is generated in the position of each vertex that is created for a surface of a point cloud that crosses a node in a planar manner.

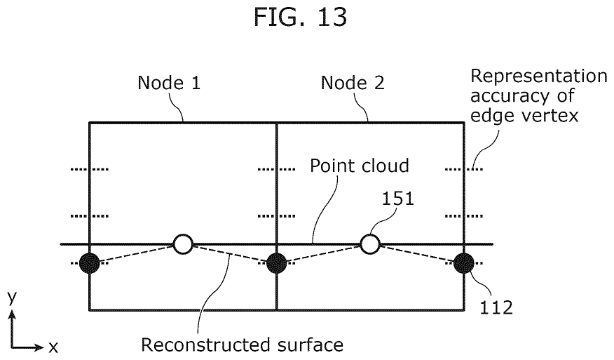

FIG. 13 is a diagram illustrating an example of generation of edge vertices and centroid vertices in this case. FIG. 13 illustrates node 1 and node 2 that are arranged in an x direction. For example, the accuracy of edge vertex 112 is ¼ of the representation capability (the 8th position) of the edge length when the node width is 32. On the other hand, centroid vertices 151 have the accuracy of integer coordinates.

As illustrated in FIG. 13, this reconstructed surface obtained from vertices with differences in the height positions (y coordinate) has a waved shape, and does not become a flat surface as in the original point cloud. It should be noted that a surface is formed from, for example, a plurality of triangles generated based on a group of vertices in one or more nodes.

As a solution to this problem, although it is also conceivable to improve the accuracy of position of an edge vertex, there is a problem that when the accuracy is uniformly improved, the data amount of the edge vertex in a region for which improvement in accuracy is not required is also uniformly increased. In addition, there is a problem that when variable bit allocation that changes the number of bits of data for each edge vertex is used, processing becomes complicated. Thus, neither method is practical.

### Solution

In the present embodiment, the decoding device adjusts the position of an edge vertex, when it can be estimated that a point cloud in a node has been a flat surface by using the positional relationship between a centroid vertex and a face vertex. Accordingly, a surface to be reconstructed can be formed into a flat surface.

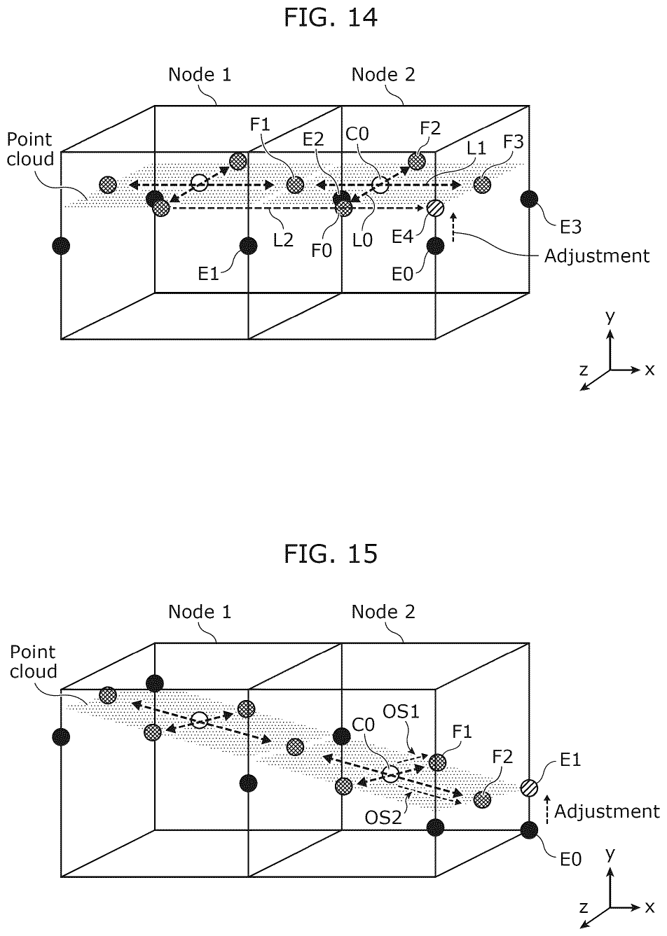

FIG. 14 is a diagram for describing this adjusting method of edge vertices. FIG. 14 illustrates node 1 and node 2 that are arranged in the x direction. In addition, node 2 is a current node to be processed. Node 2 includes centroid vertex C0, edge vertices E0, E1, E2, and E3, and face vertices F0, F1, F2, and F3.

It should be noted that, for example, only one centroid vertex is generated for one node. At most one edge vertex is generated per edge (that is, only one is generated, or not generated). At most one face vertex is generated per face.

First, before the processing of reconstructing a surface by using a plurality of vertices in a current node, the decoding device determines whether a pair of face vertices (for example, F0 and F2) belonging to opposing faces and centroid vertex C0 form a straight line. For example, the decoding device determines whether centroid vertex C0 exists on straight line L0 that passes through face vertex F0 and face vertex F2. A pair of face vertices (for example, F0 and F2) that satisfies this condition is called a pair of linear vertices. It should be noted that centroid vertex C0 existing on straight line L0 may mean, for example, that the distance between straight line L0 and centroid vertex C0 is less than a predetermined threshold value.

Furthermore, the decoding device determines whether a pair of linear vertices (for example, F1 and F3) also exists in other opposing faces. For example, the decoding device determines whether centroid vertex C0 exists on straight line L1 that passes through face vertex F1 and face vertex F3. Then, when two pairs of linear vertices exist, the decoding device determines that the original point cloud is a flat surface. In addition, in the example of FIG. 14, since a pair of linear vertices exists in the two faces facing each other in a z direction and the two faces facing each other in the x direction, it is determined that a flat surface of the original point cloud exists in an xz plane. In addition, a condition in which two pairs of linear vertices exist in a current node as described above is called a 2-straight-line-in-a-node condition.

Here, the case where a face vertex exists on a straight line connecting centroid vertices of neighboring nodes means that the original point cloud has existed on the straight line.

In addition, as another method of determining a pair of linear vertices, it may be determined whether two vectors from centroid vertex C0 to respective face vertices (for example, F0 and F2) of two opposing surfaces have the same direction. Here, the two vectors having the same direction may be a case where the difference in the directions of the vectors is 0 degrees or 180 degrees, or falls within a certain range from these criteria. It should be noted that, here, although the example of using the vectors will be described, directions may be used instead of vectors. In addition, also in the following description, directions may be similarly used instead of vectors.

For example, the decoding device may use the following method as a method of obtaining a flat surface by using an equation. The decoding device calculates the cross product of a line segment connecting a pair of face vertices that face each other in a node, and a line segment connecting a pair of other face vertices that face each other. Next, the decoding device obtains a flat surface whose normal direction is equal to the calculated cross product as a flat surface that includes face vertices and a centroid vertex.

In addition, for a node that is determined to have a flat surface, the decoding device adjusts the position of an edge vertex from the positions of the face vertices and the centroid vertex. Accordingly, the accuracy of the position of an edge vertex can be increased, and a flat surface can be reconstructed from these group of vertices.

In addition, for a node that is not determined to have a flat surface, the decoding device performs normal surface reconstruction processing, without adjusting the position of an edge vertex.

For example, as illustrated in FIG. 14, edge vertex E0 is adjusted to edge vertex E4. Specifically, the decoding device may move the edge vertex (E0) on an edge of a node to the intersecting position (the position of E4) of the estimated flat surface and the edge.

Alternatively, the decoding device may move the edge vertex (E0) on an edge to the intersecting position (the position of E4) of a straight line (L2 in FIG. 14) connecting two face vertices that belong to a continuous surface between neighboring nodes, and the edge.

It should be noted that although FIG. 14 illustrates the example in which only edge vertex E0 is adjusted, edge vertices E1, E2, and E3 are also adjusted similarly to edge vertex E0.

FIG. 15 is a diagram for describing another adjusting method of edge vertices. FIG. 15 illustrates an example in which node 2 is a current node, and edge vertex E0 is to be adjusted. It should be noted that other edge vertices included in node 2 may also be adjusted similar to edge vertex E0.

First, the decoding device calculates, for edge vertex E0, offset amounts OS1 and OS2 that are individual amounts of movement seen from centroid vertex C0 to two face vertices F1 and F2 generated in two surfaces sharing the edge to which edge vertex E0 belongs. Next, the decoding device adjusts the position of edge vertex E0 to the position (the position of E1) obtained by adding these offset amounts OS1 and OS2 to the position of centroid vertex C0.

It should be noted that, here, the example has been described in which, when a node is determined to have a flat surface, an erroneously generated edge vertex is adjusted, but when a node is determined to have a flat surface, the decoding device may exclude an edge vertex that exists on an edge intersecting with (orthogonal to) the flat surface from vertices to be used for flat surface reconstruction.

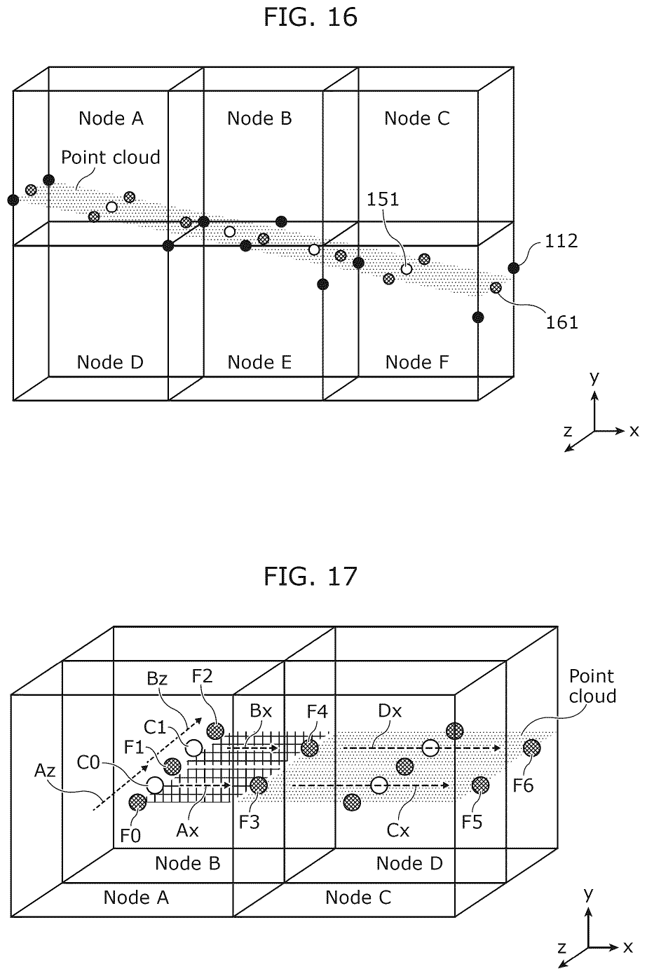

FIG. 16 is a diagram illustrating an example of a plurality of vertices in a case where an inclined surface intersects with a group of nodes in a three-dimensional manner. Also in this case, the inclined surface can be reconstructed with the above-described technique. Specifically, centroid vertex 151 and face vertex 161 are generated in each of node B and node E illustrated in FIG. 16. Even in this case, since centroid vertex 151 and face vertex 161 are linearly arranged, determination of a flat surface can be individually executed in each node.

With the above method, the decoding device determines whether a current node has a flat surface, and adjusts an edge vertex when the current node has a flat surface. Accordingly, since a flat surface can be correctly reconstructed, the accuracy of a point cloud to be reconstructed can be improved. In addition, in the above-described method, it is possible to realize the determination of whether a current node has a flat surface and the adjustment of an edge vertex, only by using the information in the current node (without using the information of a neighboring node).

It should be noted that, as the method of determining whether or not the original point cloud is to be reconstructed on a flat surface spanning a neighboring node, methods other than the above-described method may be used. For example, the decoding device may perform the determination by using a first centroid vertex of a first node adjacent to a current node in a first direction, a second centroid vertex of a second node adjacent to the current node in a second direction orthogonal to the first direction, a first face vertex generated in a surface of the current node adjacent to the first node, and a second face vertex generated in a surface of the current node adjacent to the second node. For example, the decoding device may determine that the current node has a flat surface, when these four vertices are included in the same flat surface.

Although the example of determining the case where a flat surface crossing a node exists has been described above, a method of determining whether a flat surface that is interrupted within a node exists will be described below. With this method, since the area of a flat surface that can be correctly reconstructed is more increased, the quality of a point cloud to be reconstructed can be improved.

FIG. 17 is a diagram illustrating an example of vertices generated in four nodes A to D. In the example illustrated in FIG. 17, in node C and node D, a flat surface (point cloud) crossing these nodes exists, and in node A and node B, a flat surface (point cloud) exists in a right half (in an x-axis positive direction) of these nodes.

In this case, for example, although a pair of face vertices (F0 and F1) exist on opposing surfaces in node A, two pairs of linear vertices do not exist. It should be noted that a condition in which one pair of linear vertices exist in a current node is called a 1 straight-line-in-a-node condition. Similarly, although a pair of face vertices (F1 and F2) exist on opposing surfaces in node B, two pairs of linear vertices do not exist. Thus, node A and node B do not meet the aforementioned 2-straight-line-in-a-node condition.

In this case, there is a possibility that a half surface in the x-axis positive direction in node A and node B is a continuation of a flat surface continuing from the right side. In order to determine such a flat surface having a half surface in a node, the decoding device performs the following determination.

when a current node satisfies the 1-straight-line-in-a-node condition, and a 1-straight-line-outside-a-node condition is satisfied in other direction (the x-axis positive direction in the example of FIG. 17) orthogonal to the direction (the z direction in the example of FIG. 17) that satisfies the 1-straight-line-in-a-node condition, the decoding device determines that a flat surface exists in a half surface in the other direction (the x-axis positive direction side). Here, the 1-straight-line-outside-a-node condition is that the direction of straight line Ax formed by centroid vertex C0 and face vertex F3 in node A and the direction of straight line Cx formed by a pair of linear vertices (F3 and F5) in neighboring node C in a direction Ax are the same, or have the difference less than a predetermined value.

Also in node B, since a current node satisfies the 1-straight-line-in-a-node condition, and the 1-straight-line-outside-a-node condition is satisfied in the other direction (the x-axis positive direction in the example of FIG. 17) orthogonal to the direction (the z direction in the example of FIG. 17) that satisfies the 1-straight-line-in-a-node condition, it is determined that a flat surface exists in a half surface in the other direction (x-axis positive direction). Specifically, in node B, since the direction of straight line Bx formed by centroid vertex C1 and face vertex F4 and the direction of straight line Dx formed by a pair of linear vertices (F4 and F6) in neighboring-node D in a direction Bx are the same, or have the difference less than the predetermined value, it is determined that the flat surface exists in the half surface on the x-axis positive direction side in node B.

The decoding device adjusts the positions of edge vertices on edges that intersect with the region of a half surface as in the above-described processing of the flat surface, so as to reconstruct a surface in the current node. It should be noted that an edge vertex is not illustrated in FIG. 17.

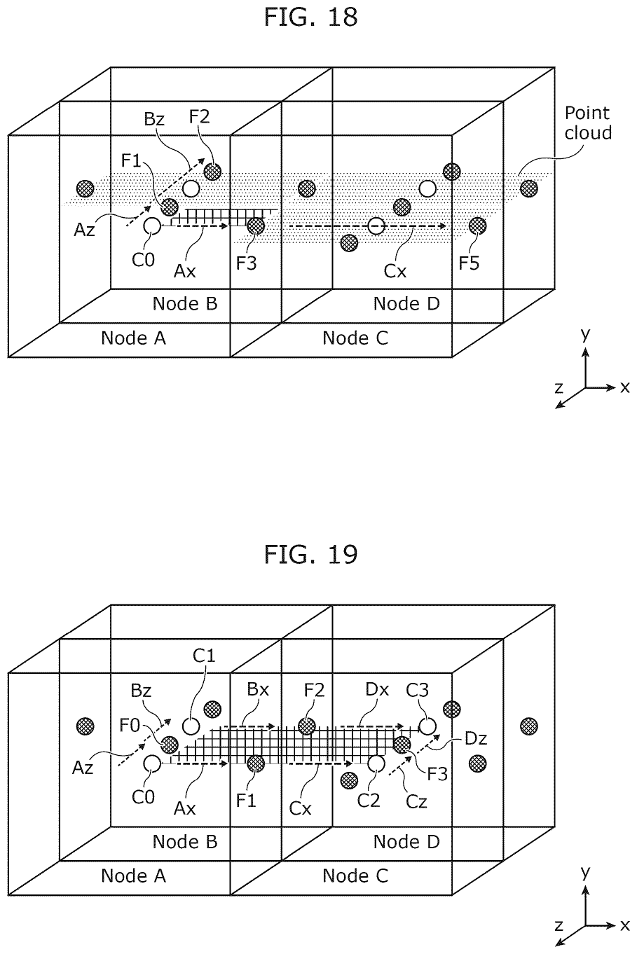

FIG. 18 is a diagram illustrating an example of vertices generated in four nodes A to D. In the example illustrated in FIG. 18, in node B, node C, and node D, a flat surface (point cloud) crossing these nodes exists, and in node A, a flat surface (point cloud) exists in a ¼ surface on a right back side (a z-axis negative direction and the x-axis positive direction) of the node.

In this example, node A does not satisfy the 2-straight-line-in-a-node condition and the 1-straight-line-in-a-node condition. In this case, the decoding device determines whether or not the above-described 1-straight-line-outside-a-node condition is satisfied in two directions. It should be noted that a condition in which the 1-straight-line-outside-a-node condition is satisfied in two directions is called a 2-straight-line-outside-a-node condition.

In the example of FIG. 18, face vertex F1 exists in a border surface between node A and node B adjacent to node A in the z-axis negative direction, and node B has a pair of vertices (F1 and F2) on a straight line, and the direction of straight line Az formed by centroid vertex C0 and face vertex F1 in node A and the direction of straight line Bz formed by the pair of linear vertices (F1 and F2) in neighboring node B are the same, or have the difference less than the predetermined value.

In addition, face vertex F3 exists in a border surface between node A and node C adjacent to node A in the x-axis positive direction, and node C has a pair of vertices (F3 and F5) on a straight line in the same direction (x-axis direction), and the direction of straight line Ax formed by centroid vertex C0 and face vertex F3 in node A and the direction of straight line Cx formed by the pair of linear vertices (F3 and F5) in neighboring node C are the same, or have the difference less than the predetermined value.

In this case, the decoding device estimates that a ¼ region in the x-axis positive direction and the z-axis negative direction in node A is a flat surface region that continues from the neighboring nodes. In this manner, in each of the neighboring nodes in the two directions, when a pair of vertices on a straight line exist in the direction from the current node to the neighboring node, the decoding device estimates that the ¼ region of the current node is a similar flat surface. In addition, the decoding device adjusts the positions of edge vertices generated on edges that intersect with the flat surface, so as to reconstruct a surface in the current node. It should be noted that an edge vertex is not illustrated in FIG. 18.

FIG. 19 is a diagram illustrating an example of vertices generated in four nodes A to D. In the example illustrated in FIG. 19, a flat surface (point cloud) exists in a ¼ surface in node A to node D. Specifically, the ¼ flat surface exists in the z-axis negative direction and the x-axis positive direction in node A, in a z-axis positive direction and the x-axis positive direction in node B, in the z-axis negative direction and the x-axis negative direction in node C, and in the z-axis positive direction and the x-axis negative direction in node D.

As illustrated in FIG. 19, even in a case where a node determined to have a flat surface does not exist in the above-described determination, when a face vertex is generated in the border surface between each of the neighboring four nodes, the decoding device determines four ¼ surfaces in the respective nodes to be flat surfaces.

Specifically, (1) when the direction of straight line Az formed by centroid vertex C0 and face vertex F0 in the z-axis negative direction in node A and the direction of straight line Bz formed by centroid vertex C1 and face vertex F0 in the z-axis positive direction in node B are the same, or have the difference less than the predetermined value, and (2) when the direction of straight line Ax formed by centroid vertex C0 and face vertex F1 in the x-axis positive direction in node A and the direction of straight line Cx formed by centroid vertex C2 and face vertex F1 in the x-axis negative direction in node C are the same, or have the difference less than the predetermined value, and (3) when the direction of straight line Bx formed by centroid vertex C1 and face vertex F2 in the x-axis positive direction in node B and the direction of straight line Dx formed by centroid vertex C3 and face vertex F2 in the x-axis negative direction in node D are the same, or have the difference less than the predetermined value, and (4) when the direction of straight line Cz formed by centroid vertex C2 and face vertex F3 in the z-axis negative direction in node C and the direction of straight line Dz formed by centroid vertex C3 and face vertex F3 in the z-axis positive direction in node D are the same, or have the difference less than the predetermined value, the decoding device determines the ¼ flat surface exists in each of nodes A to D. It should be noted that the above-described conditions are called the collection of 2-straight-line-outside-a-node conditions.

In addition, the decoding device adjusts the positions of edge vertices generated on edges that intersect with the flat surface, so as to reconstruct a surface in the current node. It should be noted that edge vertices are not illustrated in FIG. 19.

It should be noted that in the case where the decoding device determines that a flat surface exists in the half surface in the aforementioned node or in the ¼ surface in the node, when the flat surface continues to just before an end of a slice, even when a face vertex does not exist in a node in the end of the slice or in a slice cut surface, based on the continuity of a node that has the flat surface up to the node, the decoding device may determine the entire surface of the node to be a flat surface.

For example, in the example illustrated in FIG. 17, when a left surface (the surface in the x-axis negative direction) of node A is an end of a slice, the entire surface of node A may be determined to be a flat surface. In this case, the decoding device adjusts the positions of edge vertices generated on edges that intersect with the flat surface, so as to reconstruct a surface in the current node.

Here, the information in the above-described node required for the flat surface reconstruction processing in the node is only a centroid vertex and a face vertex, and the coordinates of the reconstructed edge vertex itself is information unnecessary for the flat surface reconstruction processing. Therefore, for reconstruction of the transmission data amount, the encoding device may experimentally perform the above-described flat surface reconstruction processing once, and need not perform transmission of the information of an edge vertex for a node that meets a flat surface reconstruction condition. That is, the encoding device need not store, in a bitstream, the information of the edge vertex of the node that meets the flat surface reconstruction condition.

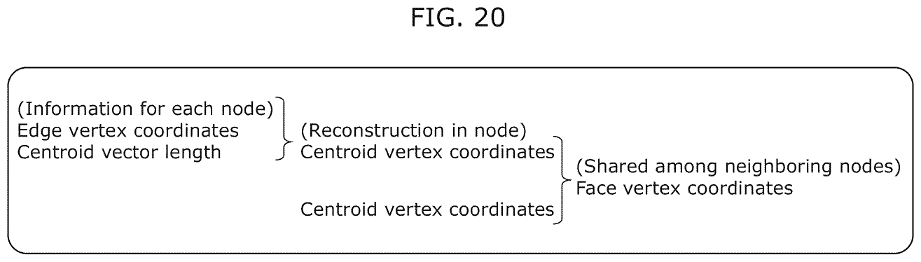

FIG. 20 is a diagram illustrating the dependency relationship of the information in reconstruction of vertex coordinates in a node in a TriSoup scheme. As illustrated in FIG. 20, the coordinates of an edge vertex and the centroid vector length are transmitted as the information for each node. Here, a centroid vector is a vector that extends in the normal direction of an approximate surface passing through a plurality of edge vertices, and extends from the approximate surface toward a centroid vertex. The decoding device calculates the coordinates of the centroid vertex for each node, by using these items of information. In addition, the decoding device calculates the coordinates of a face vertex from the coordinates of two centroid vertices of neighboring nodes.

Thus, for a node that does not transmit edge vertex coordinates, the dependency relationship for reconstructing vertices collapses, and it becomes impossible to reconstruct the centroid vertex and the face vertex. In contrast, for a node that does not transmit the edge vertex coordinates, the encoding device does not transmit the centroid vector length, either. In addition, the encoding device adds, to a bitstream, an edge vertex no transmission flag indicating whether or not to transmit the edge vertex coordinates, and transmits the coordinates of the centroid vertex. Accordingly, the decoding device can reconstruct the coordinates of the centroid vertex and the coordinates of the face vertex.

It should be noted that although the face vertex is used for the determination of a flat surface in the above-described description, the determination of a flat surface may be performed by connecting the centroid vertices of neighboring nodes, without using the face vertex.

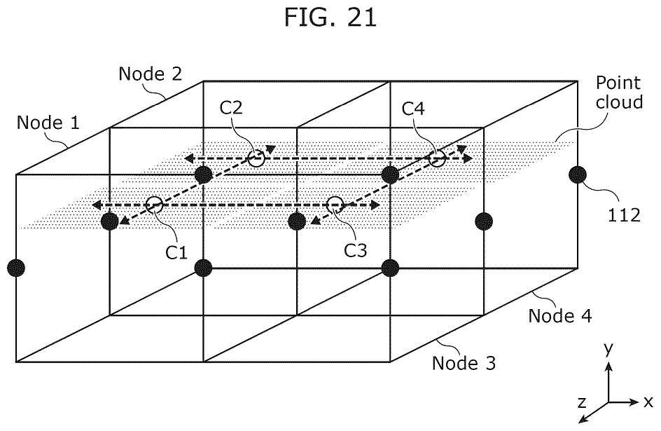

FIG. 21 is a diagram illustrating an example of the centroid vertices generated in four nodes 1 to 4 and edge vertices 112. In this case, the decoding device may determine that a flat surface exists when, for example, centroid vertices C1 to C4 of nodes 1 to 4 are included in the same flat surface. The decoding device adjusts the positions of edge vertices generated on edges that intersect with the flat surface, so as to reconstruct a surface in the current node.

It should be noted that the following method may be used as the method of determining whether or not the original point cloud is to be reconstructed on the flat surface spanning a neighboring node. For example, when the first centroid vertex of the first node adjacent to the current node in the first direction and the centroid vertex of the current node are connected to each other, and the second centroid vertex of the second node adjacent to the current node in the second direction orthogonal to the first direction and the centroid vertex of the current node are connected to each other, the decoding device may determine that the current node has a flat surface. For example, the information indicating whether or not the first centroid vertex and the centroid vertex of the current node are connected to each other, and the information indicating whether or not the second centroid vertex and the centroid vertex of the current node are connected to each other are generated by the encoding device and stored in a bitstream. The decoding device uses these items of information to perform the above-described determination.

### [Syntax Example]

A description will be given of a syntax example of the information included in a bitstream for realizing the above-described technique.

The bitstream may include a first flag that indicates whether or not to apply the above-described scheme. When the first flag is ON, that is, when the first flag indicates that the above-described scheme is to be applied, the decoding device may perform the flat surface reconstruction processing to which the above-described scheme is applied.

The encoding device may store the first flag in, for example, an SPS (Sequence Parameter Set), a GPS (Geometry Parameter Set), a GDU (Geometry Data Unit), or a GDU header.

The SPS is metadata (a parameter set) common to a plurality of frames. The GPS is the metadata (a parameter set) related to encoding of geometry information. For example, the GPS is metadata common to a plurality of frames. The GDU is a data unit (geometry data unit) of encoded data of geometry information. The GDU header is the header (control information) of the GDU.

In addition, the first flag may be stored per node. That is, whether or not to apply the above-described scheme may be switched per node.

In addition, a parameter for switching between various methods or threshold values described in the scheme may be separately stored in a bitstream, in addition to the first flag. For example, the parameter may include the information for determining the tolerance range of the directions of two vectors at the time of determining the 2-straight-line-in-a-node condition. In addition, the parameter may include a second flag that indicates whether or not to perform the flat surface reconstruction in the above-described slice end.

These parameters may be stored in any of the SPS, the GPS, and GDU, or may be stored per node. Alternatively, the parameter may be stored in a bitstream when the first flag is ON, or may be always stored in a bitstream, irrespective of the value of the first flag.

### [Flowchart]

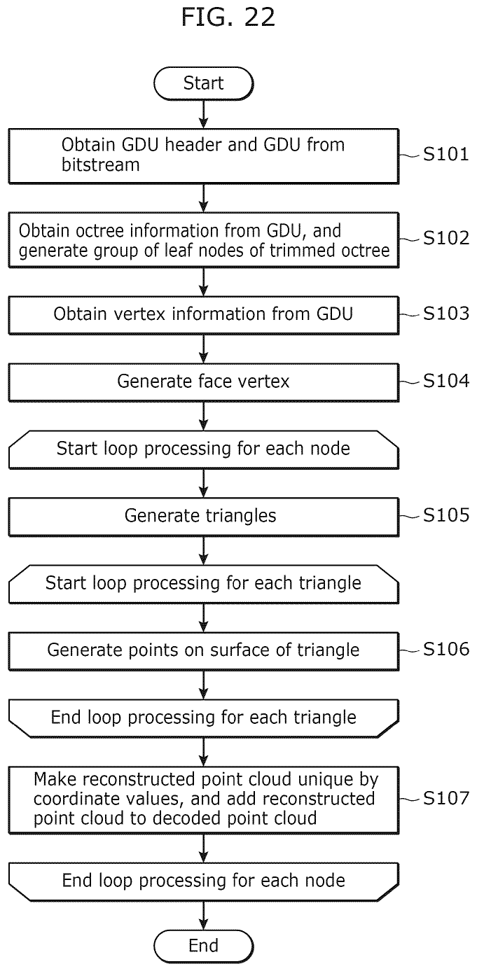

FIG. 22 is a flowchart of decoding processing by the decoding device. First, the decoding device obtains a GDU header and a GDU from a bitstream (S101). Next, the decoding device performs entropy decoding on octree information from the GDU, and generates a plurality of leaf nodes (a group of leaf nodes) of a trimmed octree by using the octree information (S102).

Next, the decoding device obtains, from the GDU, vertex information that indicates the positions of edge vertices and a centroid vertex (S103). Specifically, the decoding device obtains the vertex information by performing entropy decoding on the encoded vertex information included in the GDU.

Next, the decoding device generates a face vertex for each leaf node (hereinafter also simply written as a node) (S104). For example, in each node, the decoding device connects the centroid vertex of a current node and the centroid vertex of a neighboring node according to conditions, and generates a face vertex at the intersecting position of the obtained line segment and a node boundary.

Next, the decoding device performs the processing (loop processing) in the following steps S105 to S107 for each of the plurality of nodes of the trimmed octree. First, the decoding device connects a group of vertices (the plurality of edge vertices, the centroid vertex, and the face vertex) in the current node to generate a plurality of triangles (TriSoup surfaces) (S105).

Next, the decoding device performs the processing (loop processing) in the following step S106 for each of the plurality of triangles in the current node. The decoding device generates a plurality of points on a surface of a target triangle (S106). As a result of the above, the loop processing for each of the triangles ends.

Next, the decoding device makes a reconstructed point cloud unique in each node by coordinate values, and adds the reconstructed point cloud to a decoded point cloud (S107). Here, making a reconstructed point cloud unique means excluding points with duplicate coordinate values. As a result of the above, the loop processing for each node ends.

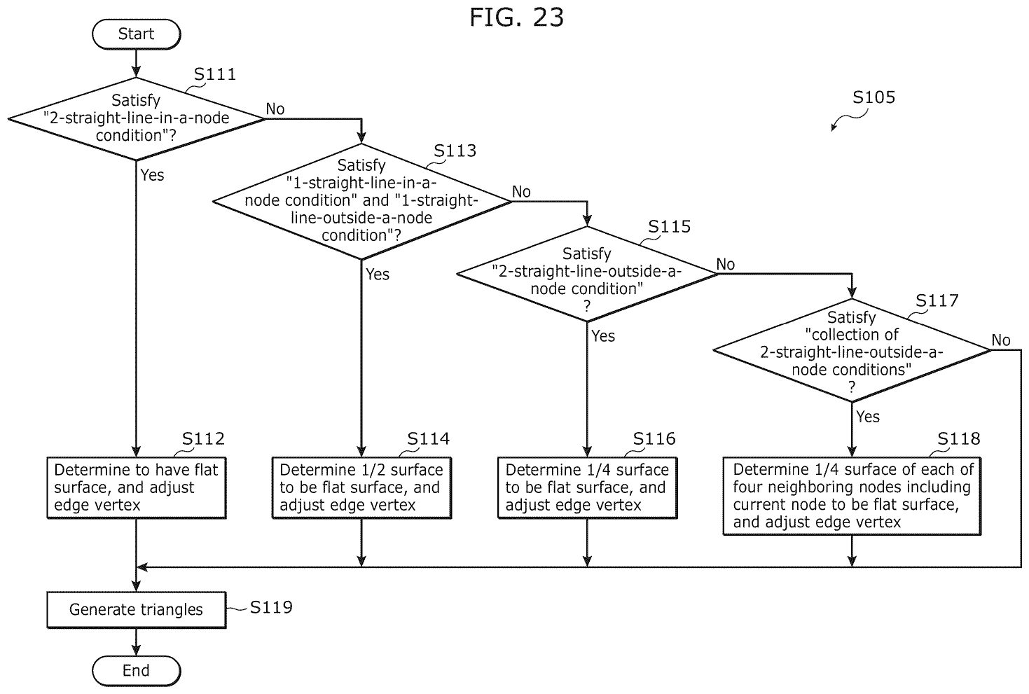

FIG. 23 is a flowchart of the generation processing of a plurality of triangles (S105). First, the decoding device determines whether or not the current node satisfies “the 2-straight-line-in-a-node condition” described above (S111). When the current node satisfies “the 2-straight-line-in-a-node condition” (Yes in S111), the decoding device determines that the current node has a flat surface, and adjusts the position of an edge vertex on an edge that intersects with the flat surface to, for example, a position on the flat surface (S112).

When the current node does not satisfy “the 2-straight-line-in-a-node condition” (No in S111), the decoding device determines whether or not the current node satisfies “the 1-straight-line-in-a-node condition” and “the 1-straight-line-outside-a-node condition” described above (S113). When the current node satisfies both “the 1-straight-line-in-a-node condition” and “the 1-straight-line-outside-a-node condition” (Yes in S113), the decoding device determines that a flat surface exists in a half surface of the current node, and adjusts the position of an edge vertex on an edge that intersects with the flat surface to, for example, a position on the flat surface (S114).

When the current node does not satisfy at least one of “the 1-straight-line-in-a-node condition” and “the 1-straight-line-outside-a-node condition” (No in S113), the decoding device determines whether or not the current node satisfies “the 2-straight-line-outside-a-node condition” described above (S115). When the current node satisfies “the 2-straight-line-outside-a-node condition” (Yes in S115), the decoding device determines that a flat surface exists in a ¼ surface of the current node, and adjusts the position of an edge vertex on an edge that intersects with the flat surface to, for example, a position on the flat surface (S116).

When the current node does not satisfy “the 2-straight-line-outside-a-node condition” (No in S115), the decoding device determines whether or not the current node satisfies “the collection of 2-straight-line-outside-a-node conditions” described above (S117). When the current node satisfies “the collection of 2-straight-line-outside-a-node conditions” (Yes in S117), the decoding device determines that a flat surface exists in a ¼ surface of each of four neighboring nodes including the current node, and adjusts the position of an edge vertex on an edge that intersects with the flat surface to, for example, a position on the flat surface (S118). It should be noted that the four neighboring nodes are, for example, a group of nodes in which each node is adjacent to the other two nodes in the same flat surface, as in node A to node D illustrated in FIG. 19.

After step S112, S114, S116 or S118, the decoding device generates a plurality of triangles by using a plurality of edge vertices including the adjusted edge vertices, the centroid vertex, and a plurality of face vertices (S119).

On the other hand, when the current node does not satisfy “the collection of 2-straight-line-outside-a-node conditions” (No in S117), the decoding device does not perform adjustment of an edge vertex, and generates a plurality of triangles by using the centroid vertex, the plurality of edge vertices, and the plurality of face vertices (S119).

It should be noted that not all of the determinations illustrated in FIG. 23 need to be necessarily performed, and only a part of the determinations may be performed. An order of determination is an example, determination may be performed in a different order, and determination may be performed in parallel.

### Embodiment 2

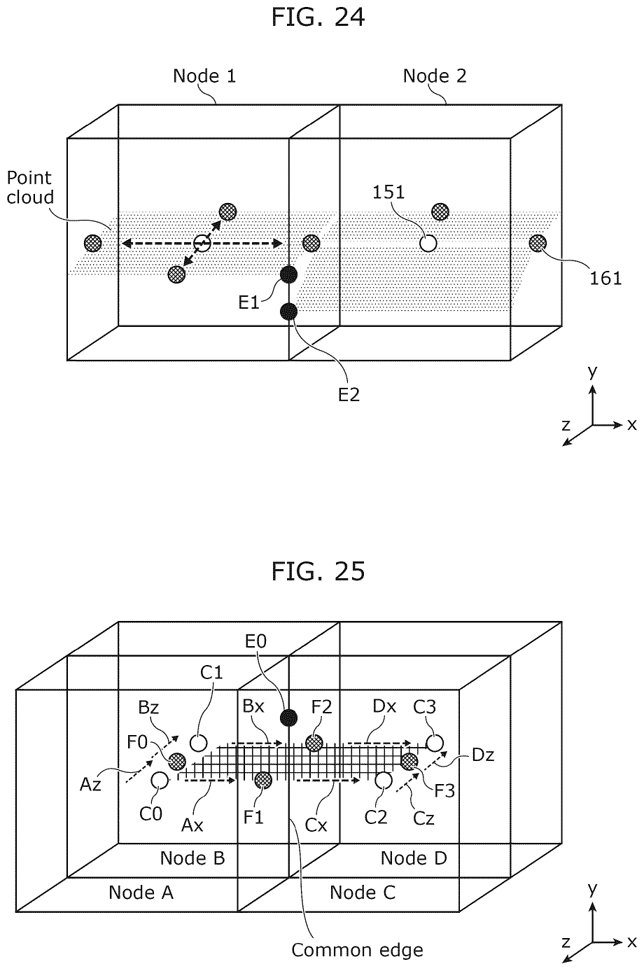

Although it is possible to estimate a flat surface and reconstruct the flat surface in a node by using the above-described technique in Embodiment 1, the position of a surface may not match between nodes. FIG. 24 is a diagram illustrating an example in this case, and is a diagram illustrating an example of vertices of node 1 and node 2 that are adjacent to each other. In the example illustrated in FIG. 24, it is determined that a flat surface exists in node 1, and an edge vertex is adjusted from the position of E2 to the position of E1 in the flat surface reconstruction processing of node 1. On the other hand, it is not determined that a flat surface exists in node 2, and an edge vertex is not adjusted from the position of E2 in the flat surface reconstruction processing of node 2. Accordingly, there is a problem that a gap is generated between surfaces in the boundary between node 1 and node 2, and the quality of reconstruction is deteriorated.

In the present embodiment, a technique for solving this problem will be described. In the present embodiment, when it can be estimated that a point cloud between neighboring nodes is a flat surface, based on the positional relationship between centroid vertices and face vertices of the nodes, the decoding device adjusts the position of an edge vertex shared between the nodes. Accordingly, a surface to be reconstructed can be formed into a flat surface.

FIG. 25 is a diagram for describing this processing, and is a diagram illustrating an example of vertices of node A to node D that are adjacent to each other. For example, as illustrated in FIG. 25, when face vertices F0 to F3 are generated in a plurality of shared surfaces of the four neighboring nodes, respectively, the decoding device determines the region (four ¼ surfaces) including common edges of these four neighboring nodes to be a flat surface. It should be noted that when face vertices F0 to F3 are generated in the plurality of shared surfaces of the four neighboring nodes, respectively, (1) the direction of straight line Az formed by centroid vertex C0 and face vertex F0 in the z-axis negative direction in node A and the direction of straight line Bz formed by centroid vertex C1 and face vertex F0 in the z-axis positive direction in node B are the same, or have the difference less than the predetermined value, and (2) the direction of straight line Ax formed by centroid vertex C0 and face vertex F1 in the x-axis positive direction in node A and the direction of straight line Cx formed by centroid vertex C2 and face vertex F1 in the x-axis negative direction in node C are the same, or have the difference less than the predetermined value, and (3) the direction of straight line Bx formed by centroid vertex C1 and face vertex F2 in the x-axis positive direction in node B and the direction of straight line Dx formed by centroid vertex C3 and face vertex F2 in the x-axis negative direction in node D are the same, or have the difference less than the predetermined value, and (4) the direction of straight line Cz formed by centroid vertex C2 and face vertex F3 in the z-axis negative direction in node C and the direction of straight line Dz formed by centroid vertex C3 and face vertex F3 in the z-axis positive direction in node D are the same, or have the difference less than the predetermined value.

In this case, the decoding device adjusts the position of edge vertex E0 on the shared edge by using, for example, the coordinates of the centroid vertex and a face vertex. For example, the decoding device calculates the average value of the y coordinates of four centroid vertices (C0 to C3) of four nodes, and adjusts the y coordinate of edge vertex E0 to the calculated average value. It should be noted that the decoding device may calculate the average value of the y coordinates of four face vertices (F0 to F3) of the four nodes, and adjust the y coordinate of edge vertex E0 to the calculated average value.

In addition, as a result of this determination of a flat surface, when the flat surface continues to just before an end of a slice, even when a face vertex does not exist in a node in the end of the slice or in a slice cut surface, based on the continuity of a node that has the flat surface up to the node, the decoding device may determine the entire surface of the node to be a flat surface. In this case, the decoding device may adjust an edge vertex by using the positions of the centroid vertex and the face vertices, as in the above-described flat surface determination processing.

It should be noted that, also in the present embodiment, various modifications similar to those in the above-described Embodiment 1 may be applied. In addition, a syntax example similar to that in Embodiment 1 may be used.

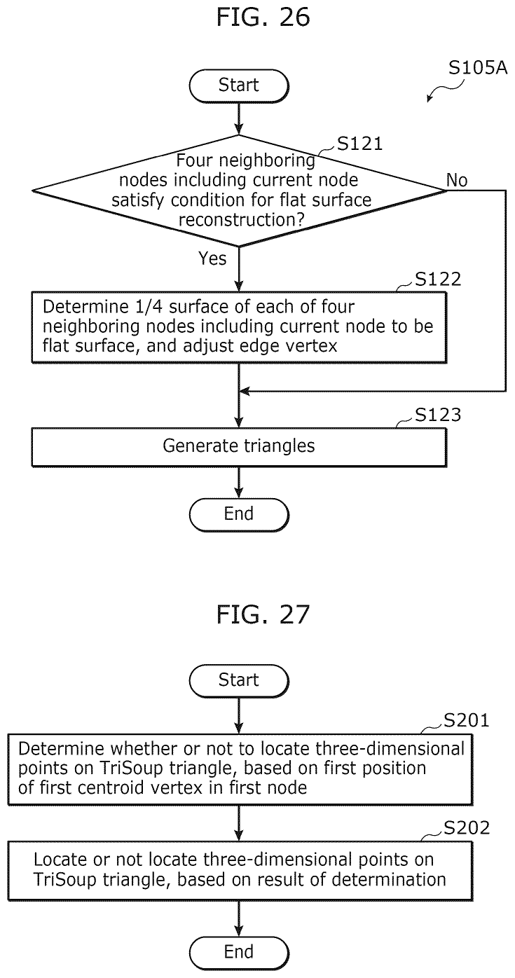

It should be noted that the flowchart of the decoding device in the present embodiment is different from the flowchart illustrated in FIG. 22 in that step S105 is replaced with step S105A. FIG. 26 is a flowchart of this generation processing of a plurality of triangles (S105A).

First, the decoding device determines whether or not four neighboring nodes including a current node satisfy a determination condition for flat surface reconstruction (S121). Here, the determination condition for flat surface reconstruction is, for example, a case where a face vertex is generated in each of a plurality of shared surfaces of the four neighboring nodes as described above.

When the four neighboring nodes satisfy the determination condition for flat surface reconstruction (Yes in S121), the decoding device determines that each ¼ surface of the four neighboring nodes including the current node to be a flat surface, and adjusts the position of an edge vertex on a shared edge shared by the four ¼ surfaces to, for example, a position on a flat surface (S122). That is, the position of the edge vertex on the shared edge is adjusted for the four neighboring nodes at once. Next, the decoding device generates a plurality of triangles by using a plurality of edge vertices including the adjusted edge vertex, the centroid vertex, and a plurality of face vertices (S123).

On the other hand, when the four neighboring nodes do not satisfy the determination condition for flat surface reconstruction (No in S121), the decoding device does not perform adjustment of an edge vertex, and generates a plurality of triangles by using the centroid vertex, the plurality of edge vertices, and the plurality of face vertices (S123).

It should be noted that, here, although the example has been described in which only the determination processing of whether the four neighboring nodes satisfy the determination condition for flat surface reconstruction is performed in step S105A, in addition to this determination processing, a part or all of the plurality of determination processings illustrated in the above-described step S105 (FIG. 23) may be performed.

### [Conclusion]

The decoding device (the three-dimensional data decoding device) according to the embodiment performs the processing shown in FIG. 27. The decoding device decodes three-dimensional points. The decoding device: determines whether to locate the three-dimensional points on a TriSoup triangle, based on a first position of a first centroid vertex in a first node that is a unit for storing the three-dimensional points included in an octree structure (S201); and locates or does not locate the three-dimensional points on the TriSoup triangle, based on a result of the determining (S202). The first centroid vertex and the TriSoup triangle are used in a TriSoup scheme. For example, the TriSoup triangle is a surface that constitutes a cross section of the first node, and is a surface (approximate surface) that passes through the first centroid vertex. For example, based on the result of the determination, when it is determined that a plurality of three-dimensional points are not located on a TriSoup triangle, the plurality of three-dimensional points are not reconstructed or the plurality of three-dimensional points are reconstructed by generating a TriSoup triangle after adjusting an edge vertex position as will be described later.

Accordingly, the decoding device can appropriately generate a TriSoup triangle according to the determination result, and can improve the reproducibility of a point cloud to be decoded.

For example, in the determining (S201), whether to locate the three-dimensional points on the TriSoup triangle is determined based on the first position and a second position of a second vertex (e.g., a face vertex), the second vertex being provided on a first surface of the first node except for edges of the first surface, and the second vertex is a vertex of the TriSoup triangle. Accordingly, the decoding device can improve the accuracy of determination by using the second position of the second vertex, in addition to the first position of the first centroid vertex.

For example, in the determining (S201), whether to locate the three-dimensional points on the TriSoup triangle is determined based on the first position, the second position, and a third position of a third vertex (e.g., a face vertex), the third vertex being provided on a second surface of the first node except for edges of the second surface, the second surface is orthogonal to the first surface, and the third vertex is a vertex of the TriSoup triangle. Accordingly, the decoding device can improve the accuracy of determination by using the third position of the third vertex, in addition to the first position of the first centroid vertex and the second position of the second vertex.

For example, in the determining (S201), whether to locate the three-dimensional points on the TriSoup triangle is determined based on (i) first information that indicates whether the first centroid vertex is connected to a second centroid vertex in a second node adjacent to the first node by the TriSoup triangle and (ii) second information that indicates whether the first centroid vertex is connected to a third centroid vertex in a third node adjacent to the first node by the TriSoup triangle. The connection by a TriSoup triangle means that a triangle in the first node and a triangle in the second node are generated to be continuous with each other and substantially parallel to each other.

For example, when the first centroid vertex, the second centroid vertex, and the third centroid vertex are connected by the TriSoup triangle, a reconstructed flat surface that spans the first node, the second node, and the third node is substantially generated. In this case, when the plurality of three-dimensional points are located on the TriSoup triangle, the reconstruction accuracy of a point cloud is increased. Therefore, according to this decoding device, it is possible to realize highly accurate determination with a small amount of processing only by referring to the first information and the second information.

For example, a TriSoup triangle includes a flat portion. For example, a TriSoup triangle includes a curved surface portion.

For example, a bitstream includes control information that indicates whether the determining is performed. Accordingly, the decoding device can switch whether or not to perform the determination.

For example, the control information is provided for each of nodes. Accordingly, the decoding device can switch whether or not to perform the determination for each of nodes.

For example, when it is determined to locate the three-dimensional points on the TriSoup triangle, a bitstream does not include information about positions of edge vertices. Accordingly, the data amount of a bitstream can be reduced.

For example, a decoding device decodes three-dimensional points. The decoding device: decodes edge vertices and a first centroid vertex that are provided in a first node, according to a TriSoup scheme, the first node being a unit for storing the three-dimensional points included in an octree structure; and adjusts at least one of positions of the edge vertices to generate a TriSoup triangle on which the three-dimensional points are to be located.

Accordingly, for example, when a flat surface (TriSoup triangle) cannot be correctly reconstructed from the plurality of vertices in the first node, the decoding device can reconstruct a correct flat surface by adjusting an edge vertex. Thus, the reproducibility of a point cloud to be decoded can be improved.

For example, in the adjusting, the at least one of the positions is adjusted based on positions of the first centroid vertex, a second vertex (e.g., a face vertex), and a third vertex (e.g., a face vertex), the TriSoup triangle is defined by the second vertex and the third vertex, the second vertex is provided on a first surface of the first node except for edges of the first surface, the third vertex is provided on a second surface of the first node except for edges of the second surface, and the second surface is orthogonal to the first surface. Accordingly, the decoding device can adjust the position of at least one edge vertex so that a flat surface can be correctly reconstructed.

For example, an accuracy of the positions of the edge vertices is lower than an accuracy of a position of the first centroid vertex and an accuracy of adjusted positions of the edge vertices. Accordingly, when a flat surface cannot be correctly reconstructed due to low accuracy of the positions of the edge vertices, the decoding device can correctly reconstruct a flat surface.

For example, a decoding device decodes three-dimensional points. The decoding device: determines whether to locate the three-dimensional points on a TriSoup triangle, based on a first position of a first centroid vertex in a first node, the TriSoup triangle extending from the first centroid vertex toward a second centroid vertex in a second node; and locates or does not locate the three-dimensional points on the TriSoup triangle, based on a result of the determining. The first centroid vertex, the second centroid vertex, and the TriSoup triangle are used in the TriSoup scheme, and each of the first node and the second node is a unit for storing a plurality of three-dimensional points included in an octree structure.

Accordingly, for example, even when a flat surface (TriSoup triangle) cannot be correctly reconstructed from the plurality of vertices in the first node, the decoding device can locate the plurality of three-dimensional points on the flat surface. Thus, the reproducibility of a point cloud to be decoded can be improved.

For example, a TriSoup triangle extends to the first surface of the first node, the first node is connected to the second node, the TriSoup triangle does not extend to the second surface of the first node, and the second surface faces the first surface.

Accordingly, even when a flat surface exists in a part of the first node, the decoding device can locate a plurality of three-dimensional points on the flat surface. Thus, the reproducibility of a point cloud to be decoded can be improved.

For example, a decoding device decodes three-dimensional points. The decoding device calculates, in a first direction, an average position of four positions of four vertices each of which is included in a different one of four nodes. The four nodes include a common edge that is parallel to the first direction, and each of the four nodes is a unit for storing three-dimensional points included in an octree structure. The decoding device further generates an edge vertex on the common edge, at the average position. The edge vertex and each of the four vertices are used in a TriSoup scheme that generates three-dimensional points on a TriSoup triangle.

Accordingly, for example, even when a flat surface (TriSoup triangle) cannot be correctly reconstructed from a plurality of original vertices of the four nodes, the decoding device can reconstruct a correct flat surface by using the generated edge vertex. Thus, the reproducibility of a point cloud to be decoded can be improved.

For example, an original position of the edge vertex is stored into a bitstream, and in the generating, the original position is changed to the average position on the common edge. Accordingly, since the edge vertex can be generated in the decoding device, it is unnecessary to generate additional information or the like in the encoding device. Therefore, the processing amount in the encoding device can be reduced.

For example, the four vertices are centroid vertices or face vertices, and each of the face vertices is provided on a surface of a corresponding one of the four nodes except for edges of the corresponding one of the four nodes. Accordingly, the decoding device can appropriately generate an edge vertex by using the average position of the four vertices.

For example, the four nodes include: a first node; a second node adjacent to the first node in a second direction orthogonal to the first direction; a third node adjacent to the first node in a third direction orthogonal to each of the first direction and the second direction; and a fourth node adjacent to the second node in the third direction and adjacent to the third node in the second direction.

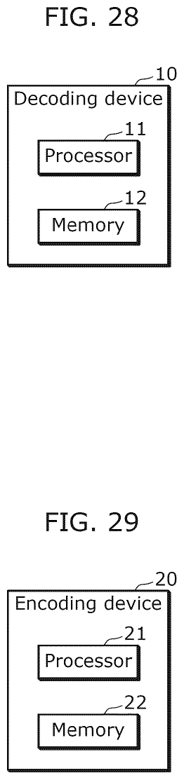

FIG. 28 is a block diagram of decoding device 10. For example, decoding device 10 includes processor 11 and memory 12. Using memory 12, processor 11 performs the above processing.

In addition, the encoding device (three-dimensional data encoding device) according to the embodiment may perform processing similar to that in the decoding device. For example, the encoding device may perform processing in which decoding in the above-described decoding device is replaced with encoding.

FIG. 29 is a block diagram of encoding device 20. For example, encoding device 20 includes processor 21 and memory 22. Using memory 22, processor 21 performs the above processing.

For example, the encoding device encodes a plurality of three-dimensional points according to the TriSoup scheme, so as to generate the first information that indicates the positions of at least one of a plurality of centroid vertices and a plurality of face vertices, and generates a bitstream including the first information, and the bitstream does not include the second information that indicates the positions of a plurality of edge vertices. Accordingly, the data amount of a bitstream can be reduced.

For example, the bitstream includes third information that indicates whether or not to generate the plurality of edge vertices in the decoding device. When the third information indicates that the plurality of edge vertices are to be generated in the decoding device, the bitstream does not include the second information, and when the third information does not indicate that the plurality of edge vertices are to be generated in the decoding device, the bitstream includes the second information.

For example, the decoding device receives a bitstream that includes the first information indicating the positions of at least one of a plurality of centroid vertices and a plurality of face vertices, and that does not include the second information indicating the positions of a plurality of edge vertices, generates the plurality of edge vertices by using the first information, and generates a TriSoup triangle by using at least one of the plurality of centroid vertices and the plurality of face vertices, and the plurality of generated edge vertices. Accordingly, the data amount of a bitstream can be reduced.

An encoding device (three-dimensional data encoding device), a decoding device (three-dimensional data decoding device), and the like, according to embodiments of the present disclosure and variations thereof have been described above, but the present disclosure is not limited to these embodiments, etc.

Note that each of the processors included in the encoding device, the decoding device, and the like, according to the above embodiments is typically implemented as a large-scale integrated (LSI) circuit, which is an integrated circuit (IC). These may take the form of individual chips, or may be partially or entirely packaged into a single chip.

Such IC is not limited to an LSI, and thus may be implemented as a dedicated circuit or a general-purpose processor. Alternatively, a field programmable gate array (FPGA) that allows for programming after the manufacture of an LSI, or a reconfigurable processor that allows for reconfiguration of the connection and the setting of circuit cells inside an LSI may be employed.

Moreover, in the above embodiments, the constituent elements may be implemented as dedicated hardware or may be realized by executing a software program suited to such constituent elements. Alternatively, the constituent elements may be implemented by a program executor such as a CPU or a processor reading out and executing the software program recorded in a recording medium such as a hard disk or a semiconductor memory.

The present disclosure may also be implemented as an encoding method (three-dimensional data encoding method), a decoding method (three-dimensional data decoding method), or the like executed by the encoding device (three-dimensional data encoding device), the decoding device (three-dimensional data decoding device), and the like.

Furthermore, the present disclosure may be implemented as a program for causing a computer, a processor, or a device to execute the above-described encoding method or decoding method. Furthermore, the present disclosure may be implemented as a bitstream generated by the above-described encoding method. Furthermore, the present disclosure as a recording medium on which the program or the bitstream is recorded. For example, the present disclosure may be implemented as a non-transitory computer-readable recording medium on which the program or the bitstream is recorded.

Also, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Also, the processing order of executing the steps shown in the flowcharts is a mere illustration for specifically describing the present disclosure, and thus may be an order other than the shown order. Also, one or more of the steps may be executed simultaneously (in parallel) with another step.

An encoding device, a decoding device, and the like, according to one or more aspects have been described above based on the embodiments, but the present disclosure is not limited to these embodiments. The one or more aspects may thus include forms achieved by making various modifications to the above embodiments that can be conceived by those skilled in the art, as well forms achieved by combining constituent elements in different embodiments, without materially departing from the spirit of the present disclosure.

### INDUSTRIAL APPLICABILITY

The present disclosure is applicable to an encoding device and a decoding device.

1. A decoding method for decoding three-dimensional points, the decoding method comprising:
determining whether to locate the three-dimensional points on a TriSoup triangle, based on a first position of a first centroid vertex in a first node that is a unit for storing the three-dimensional points included in an octree structure; and
locating or not locating the three-dimensional points on the TriSoup triangle, based on a result of the determining,
wherein the first centroid vertex and the TriSoup triangle are used in a TriSoup scheme.

2. The decoding method according to claim 1,
wherein in the determining, whether to locate the three-dimensional points on the TriSoup triangle is determined based on the first position and a second position of a second vertex, the second vertex being provided on a first surface of the first node except for edges of the first surface, and
the second vertex is a vertex of the TriSoup triangle.

3. The decoding method according to claim 2,
wherein in the determining, whether to locate the three-dimensional points on the TriSoup triangle is determined based on the first position, the second position, and a third position of a third vertex, the third vertex being provided on a second surface of the first node except for edges of the second surface,
the second surface is orthogonal to the first surface, and
the third vertex is a vertex of the TriSoup triangle.

4. The decoding method according to claim 1,
wherein in the determining, whether to locate the three-dimensional points on the TriSoup triangle is determined based on (i) first information that indicates whether the first centroid vertex is connected to a second centroid vertex in a second node adjacent to the first node by the TriSoup triangle and (ii) second information that indicates whether the first centroid vertex is connected to a third centroid vertex in a third node adjacent to the first node by the TriSoup triangle.

5. The decoding method according to claim 1,
wherein a bitstream includes control information that indicates whether the determining is performed.

6. The decoding method according to claim 5,
wherein the control information is provided for each of nodes.

7. The decoding method according to claim 1,
wherein when it is determined to locate the three-dimensional points on the TriSoup triangle, a bitstream does not include information about positions of edge vertices.

8. A decoding method for decoding three-dimensional points, the decoding method comprising:
decoding edge vertices and a first centroid vertex that are provided in a first node, according to a TriSoup scheme, the first node being a unit for storing the three-dimensional points included in an octree structure; and
adjusting at least one of positions of the edge vertices to generate a TriSoup triangle on which the three-dimensional points are to be located.

9. The decoding method according to claim 8,
wherein in the adjusting, the at least one of the positions is adjusted based on positions of the first centroid vertex, a second vertex, and a third vertex,
the TriSoup triangle is defined by the second vertex and the third vertex,
the second vertex is provided on a first surface of the first node except for edges of the first surface,
the third vertex is provided on a second surface of the first node except for edges of the second surface, and
the second surface is orthogonal to the first surface.

10. The decoding method according to claim 8,
wherein an accuracy of the positions of the edge vertices is lower than an accuracy of a position of the first centroid vertex and an accuracy of adjusted positions of the edge vertices.

11. A decoding method for decoding three-dimensional points, the decoding method comprising:
calculating, in a first direction, an average position of four positions of four vertices each of which is included in a different one of four nodes,
wherein the four nodes include a common edge that is parallel to the first direction,
each of the four nodes is a unit for storing three-dimensional points included in an octree structure,
the decoding method further comprises:
generating an edge vertex on the common edge, at the average position, and
the edge vertex and each of the four vertices are used in a TriSoup scheme that generates three-dimensional points on a TriSoup triangle.

12. The decoding method according to claim 11,
wherein an original position of the edge vertex is stored into a bitstream, and
in the generating, the original position is changed to the average position on the common edge.

13. The decoding method according to claim 11,
wherein the four vertices are centroid vertices or face vertices, and each of the face vertices is provided on a surface of a corresponding one of the four nodes except for edges of the corresponding one of the four nodes.

14. The decoding method according to claim 11,
wherein the four nodes include:
a first node;
a second node adjacent to the first node in a second direction orthogonal to the first direction;
a third node adjacent to the first node in a third direction orthogonal to each of the first direction and the second direction; and
a fourth node adjacent to the second node in the third direction and adjacent to the third node in the second direction.
